(19) United States
(12) Patent Application Publication
(10) Pub. No.: US 2004/0266599 A1
(43) Pub. Date: Dec. 30, 2004

(54) Parallel folding apparatus of folding machine

(76) Inventor: Kenji Fujiwara, Noda-shi (JP)

Correspondence Address: BIRCH STEWART KOLASCH & BIRCH, PO BOX 747, FALLS CHURCH, VA, 22040-0747, US

(21) Appl. No.: 10/874,228

(22) Filed: Jun. 24, 2004

(30) Foreign Application Priority Data
Jun. 27, 2003 (JP) 2003-184229

(51) Int. Cl. B31F 7/00

(52) U.S. Cl. 493/424

(57) ABSTRACT

A parallel folding apparatus includes a folding cylinder having a pin for holding a sheet, and a folding blade; a jaw cylinder having a gripper member which, in cooperation with the folding blade of the folding cylinder, changes gripping of the sheet held by the pin of the folding cylinder such that the sheet is gripped by the gripper member while being folded; and transport belts looped around the jaw cylinder. The apparatus further includes a drive shaft, support arms, guide rollers, and the like for moving, toward the jaw cylinder, portions of the corresponding transport belts located upstream of a point of closest gap between the folding cylinder and the jaw cylinder and biased toward the folding cylinder, at the time of gripping change from the folding cylinder to the jaw cylinder.

The entire disclosure of Japanese Patent Application No. 2003-184229 filed on Jun. 27, 2003 including specification, claims, drawings and summary is incorporated herein by reference in its entirety.

### BACKGROUND OF THE INVENTION

1. Field of the Invention

The present invention relates to a parallel folding apparatus of a folding machine for transversely parallel-folding sheets obtained by cutting, every predetermined length, a web printed on a rotary press.

2. Description of the Related Art

FIG. 8 schematically shows an example of the structure of a conventional parallel folding apparatus of a folding machine for transversely parallel-folding sheets obtained by cutting, every predetermined length, a web printed on a rotary press (see for example, Japanese Utility Model Registration No. 2550776).

As shown in FIG. 8, a folding cylinder 130 faces a cutting cylinder 140, on which a plurality of cutting blades (not shown) are provided at predetermined intervals along the circumferential direction in order to transversely cut a printed web 1. A plurality (three each in the present example) of retractable pins 131 and retractable folding blades 132 are alternatingly provided on the folding cylinder 130 at predetermined intervals along the circumferential direction. Each of the retractable pins 131 is adapted to hold the leading end of a sheet cut from the web 1. Each of the folding blades 132 is adapted to transversely fold the sheet at its midpoint portion.

Pin receivers (not shown) for receiving the corresponding pins 131 are provided on the cutting cylinder 140 at corresponding predetermined positions. Blade receivers (not shown) for receiving the corresponding cutting blades are provided on the folding cylinder 130 at corresponding predetermined positions. A guide plate (not shown) for guiding transport of the sheet is disposed underneath the folding cylinder 130. A jaw cylinder 120 faces the folding cylinder 130. A plurality (three in the present example) of openable gripper boards 121 are provided on the jaw cylinder 120 at predetermined intervals along the circumferential direction. Each of the gripper boards 121 is adapted to grip the sheet at its midpoint portion.

A plurality of transport belts 110 are looped around the jaw cylinder 120 while being arranged at predetermined intervals along the width direction of the jaw cylinder 120. The transport belts 110 transport a signature (the sheet folded as a result of being gripped by the gripper board 121) downward while holding the signature between the same and other corresponding transport belts (not shown) disposed in opposition to the same. In FIG. 8, reference numerals 111 to 113 denote guide rollers.

In the thus-configured conventional parallel folding apparatus of a folding machine, when the printed web 1 travels through the gap between the cutting cylinder 140 and the folding cylinder 130, the cutting blade of the cutting cylinder 140 transversely cuts the web 1 to form a sheet. The pin 131 of the folding cylinder 130 projects and sticks into a leading end portion of the sheet of the web 1, thereby holding the sheet. Thus, the sheet is transported while being guided by the above-mentioned guide plate.

When the midpoint portion of the sheet reaches the point of closest gap between the folding cylinder 130 and the jaw cylinder 120, as shown in FIG. 9, the folding blade 132 of the folding cylinder 130 projects and folds the midpoint portion of the sheet 2 into a projecting shape. Subsequently, the gripper board 121 of the jaw cylinder 120 closes to thereby grip the projecting midpoint portion of the sheet 2; the folding blade 132 of the folding cylinder 130 retracts; and the pin 131 of the folding cylinder 130 retracts to thereby release the sheet 2 from retainment on the folding cylinder 130. Thus, the sheet 2 is transferred as a transversely folded signature from the folding cylinder 130 to the jaw cylinder 120.

When the signature is transported to a position where the signature is transferred from the jaw cylinder 120 to the transport belts 110 and the like, the gripper board 121 of the jaw cylinder 120 opens to thereby release the signature from the jaw cylinder 120. The signature is transported to the next downstream process while being held by means of the transport belts 110 and the like.

When the above-described conventional parallel folding apparatus of a folding machine is operated at high speed, a rear end portion of the signature (signature tail edge) tends to “flutter” at the time of sheet transfer from the folding cylinder 130 to the jaw cylinder 120, potentially resulting in the following problem. The position of gripping by the gripper board 121 of the jaw cylinder 120 deviates from an expected position, and thus the fold accuracy of the resultant signature is impaired. Further, the signature may be dog-eared.

In order to avoid the above problem, the transport belts 110 are arranged in such a manner as to also abut the outer circumferential surface of the folding cylinder 130 in order to press the signature tail edge against the folding cylinder 130 at the time of sheet transfer from the folding cylinder 130 to the jaw cylinder 120, thereby suppressing the flutter to the greatest possible extent. However, as shown in FIG. 10, when the transport belts 110 are arranged in such a manner as to abut the folding cylinder 130 along a necessary and sufficient length to suppress the flutter, the folding blade 132 comes into contact with the transport belts 110 at the time of sheet transfer from the folding cylinder 130 to the jaw cylinder 120. As a result, the position of gripping by the gripper board 121 of the jaw cylinder 120 deviates from an expected position, and thus the fold accuracy of the resultant signature is impaired.

### SUMMARY OF THE INVENTION

In view of the foregoing, an object of the present invention is to provide a parallel folding apparatus of a folding machine capable of enhancing the fold accuracy of a signature associated with sheet transfer from a folding cylinder to a jaw cylinder in high-speed operation.

To achieve the above object, a parallel folding apparatus of a folding machine according to the present invention comprises a folding cylinder having holding means for holding a sheet, and a folding blade; a jaw cylinder opposing the folding cylinder and having a gripper member which performs, in cooperation with the folding blade of the folding cylinder, a gripping change of the sheet held by the holding means of the folding cylinder in such a manner that the sheet is gripped by the gripper member while being folded to form a signature; and a belt looped around the jaw cylinder. The parallel folding apparatus further comprises belt-moving means for moving, toward the jaw cylinder, a portion of the belt located upstream of a point of closest gap between the folding cylinder and the jaw cylinder and biased toward the folding cylinder, at the time of gripping change of the sheet from the folding cylinder to the jaw cylinder.

Preferably, the belt-moving means includes a guide roller interposed between the jaw cylinder and the belt and arranged to rotate eccentrically.

Preferably, the belt-moving means includes a pair of guide rollers interposed between the jaw cylinder and the belt; a support arm having the guide rollers rotatably attached to opposite end portions thereof; and a drive shaft adapted to rotate the support arm while supporting the support arm at a midpoint portion thereof.

Preferably, at the time of gripping change, the belt-moving means moves the belt away from the folding cylinder such that the belt retreats toward the gripper member of the jaw cylinder.

Preferably, at the time of gripping change, the belt-moving means moves the belt such that the belt is located between the center of the jaw cylinder and the position where the sheet is gripped by means of a cooperative action between the folding blade of the folding cylinder and the gripper member of the jaw cylinder.

Preferably, at a time other than the time of gripping change, the belt-moving means moves the belt such that the belt abuts a portion of the folding cylinder located upstream, in relation to a rotational direction, of the point of closest gap between the folding cylinder and the jaw cylinder.

Preferably, the belt-moving means is operated by means of a drive source of the folding machine in such a manner as to be synchronized with a rotational cycle of the jaw cylinder and the folding cylinder.

According to the parallel folding apparatus of a folding machine of the present invention, at a time other than the time of gripping change from the folding cylinder to the jaw cylinder, the belt-moving means can move the belt such that the belt abuts a portion of the folding cylinder located upstream of the point of closest gap between the folding cylinder and the jaw cylinder; and at the time of gripping change, the belt-moving means can cause the belt to leave the folding cylinder and to retreat toward the jaw cylinder. Thus, the tail edge of a signature is pressed against the folding cylinder at the time of sheet transfer from the folding cylinder to the jaw cylinder, thereby preventing contact of the belt with the folding blade engaged in gripping change from the folding cylinder to the jaw cylinder while preventing flutter of the tail edge which would otherwise result from high-speed operation. Therefore, there can be enhanced the fold accuracy of the signature associated with sheet transfer from the folding cylinder to the jaw cylinder in high-speed operation.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic structural view showing a main portion of a parallel folding apparatus of a folding machine according to an embodiment of the present invention;

FIG. 2 is a sectional view taken along line II-II of FIG. 1;

FIG. 3 is an explanatory view for explaining a state at the time of gripping change from a folding cylinder to a jaw cylinder in the parallel folding apparatus of FIG. 1;

FIG. 4 is an enlarged view of a region indicated by arrow IV of FIG. 3;

FIG. 5 is an explanatory view for explaining a state subsequent to gripping change from the folding cylinder to the jaw cylinder in the parallel folding apparatus of FIG. 1;

FIG. 6 is an explanatory view showing a power transmission system for the parallel folding apparatus according to the embodiment;

FIG. 7 is a schematic structural view showing a main portion of a parallel folding apparatus of a folding machine according to another embodiment of the present invention;

FIG. 8 is a schematic structural view showing an example of a conventional parallel folding apparatus of a folding machine;

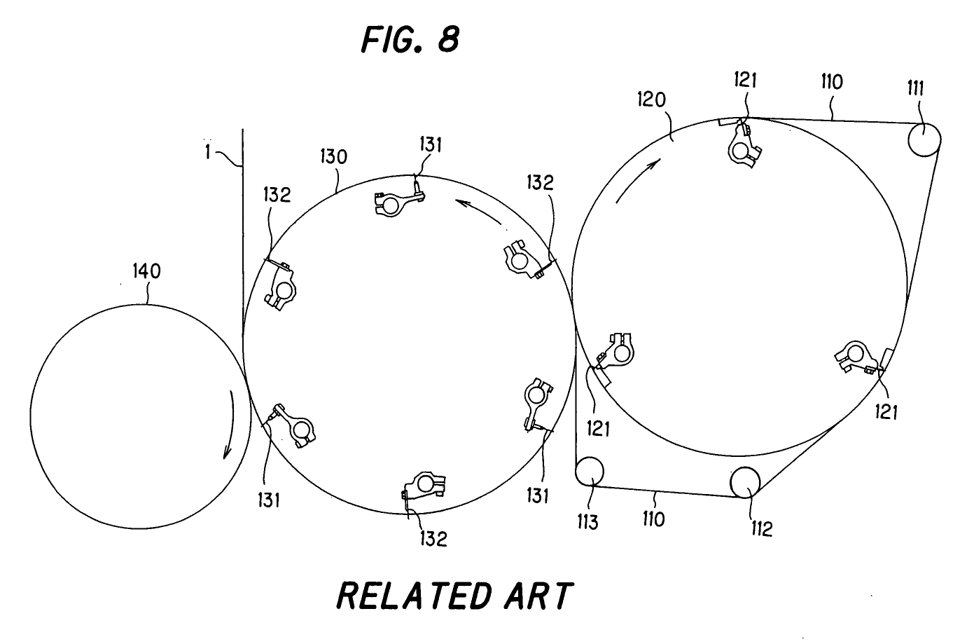

FIG. 9 is an explanatory view for explaining a state at the time of gripping change from a folding cylinder to a jaw cylinder in the conventional parallel folding apparatus; and

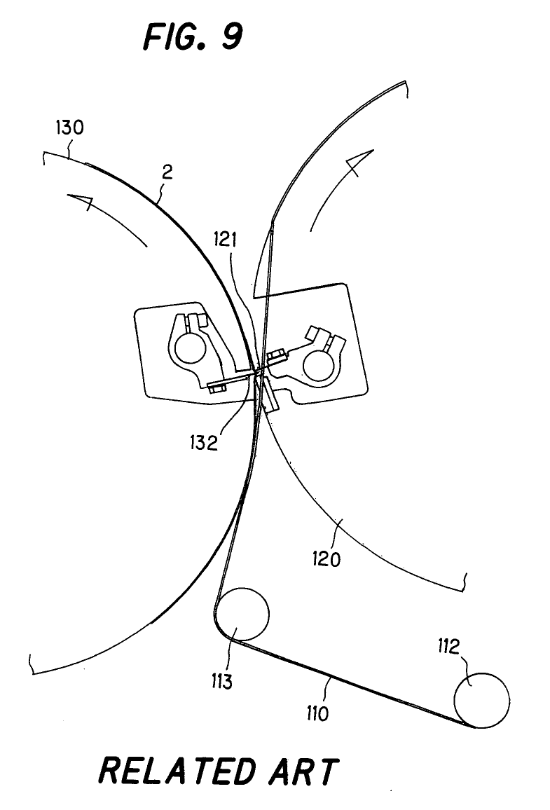

FIG. 10 is an explanatory view for explaining a problem involved in the conventional parallel folding apparatus at the time of gripping change from the folding cylinder to the jaw cylinder.

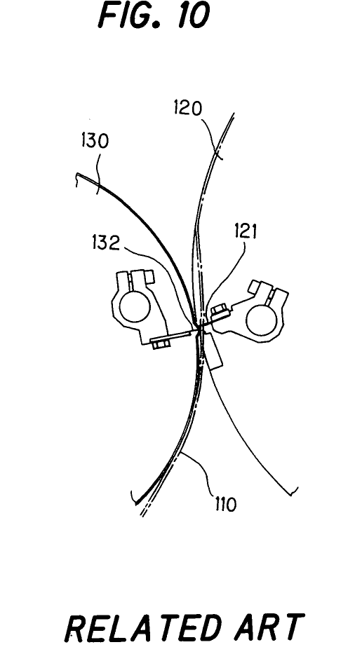

### DETAILED DESCRIPTION OF THE INVENTION

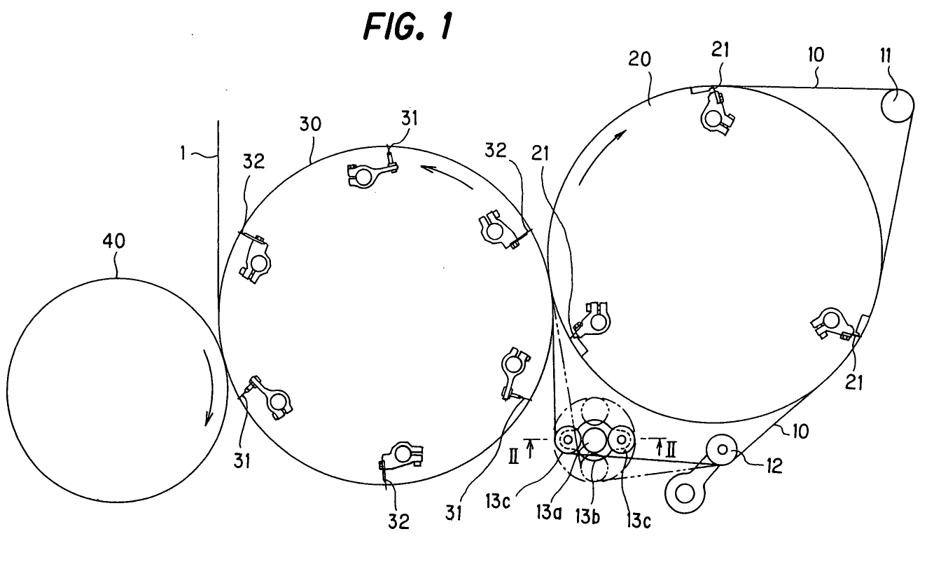

Embodiments of a parallel folding apparatus of a folding machine according to the present invention will next be described with reference to FIGS. 1 to 6.

As shown in FIG. 1, a folding cylinder 30 faces a cutting cylinder 40, on which a plurality of cutting blades (not shown) are provided at predetermined intervals along the circumferential direction in order to transversely cut a printed web 1. A plurality (three each in the present embodiment) of retractable pins 31, which serve as holding means, and a plurality (three each in the present embodiment) of retractable folding blades 32 are alternatingly provided on the folding cylinder 30 at predetermined intervals along the circumferential directions. Each of the retractable pins 31 is adapted to hold the leading end of a sheet cut from the web 1. Each of the folding blades 32 is adapted to transversely fold the sheet at its midpoint portion.

Pin receivers (not shown) for receiving the corresponding pins 31 are provided on the cutting cylinder 40 at corresponding predetermined positions. Blade receivers (not shown) for receiving the corresponding cutting blades are provided on the folding cylinder 30 at corresponding predetermined positions. A guide plate (not shown) for guiding transport of the sheet is disposed underneath the folding cylinder 30. A jaw cylinder 20 faces the folding cylinder 30. A plurality (three in the present embodiment) of openable gripper boards 21, which serve as gripper members, are provided on the jaw cylinder 20 at predetermined intervals along the circumferential direction. Each of the gripper boards 21 is adapted to grip the sheet at its midpoint portion.

A plurality of transport belts 10 are looped around the jaw cylinder 20 while being arranged at predetermined intervals along the width direction of the jaw cylinder 20. A plurality of guide rollers 11 for guiding the traveling direction of the transport belts 10 are provided downstream (at the upper right in FIG. 1), in relation to the rotational direction, of the point of closest gap between the jaw cylinder 20 and the folding cylinder 30 and are located between the jaw cylinder 20 and the transport belt 10, while being arranged at predetermined intervals along the width direction of the jaw cylinder 20. A plurality of tension rollers 12 for retaining tension of the transport belt 10 are provided upstream (at the bottom in FIG. 1), in relation to the rotational direction, of the point of closest gap between the jaw cylinder 20 and the folding cylinder 30 and are located between the jaw cylinder 20 and the transport belt 10, while being arranged at predetermined intervals along the width direction of the jaw cylinder 20.

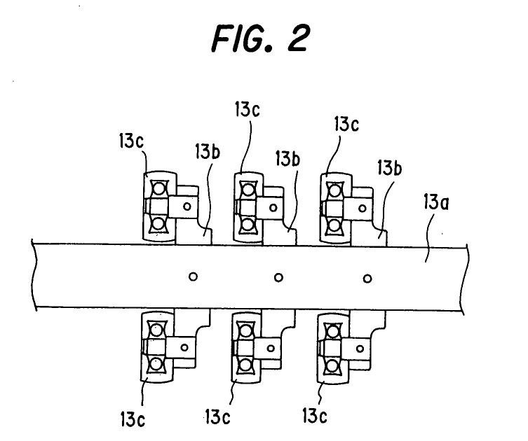

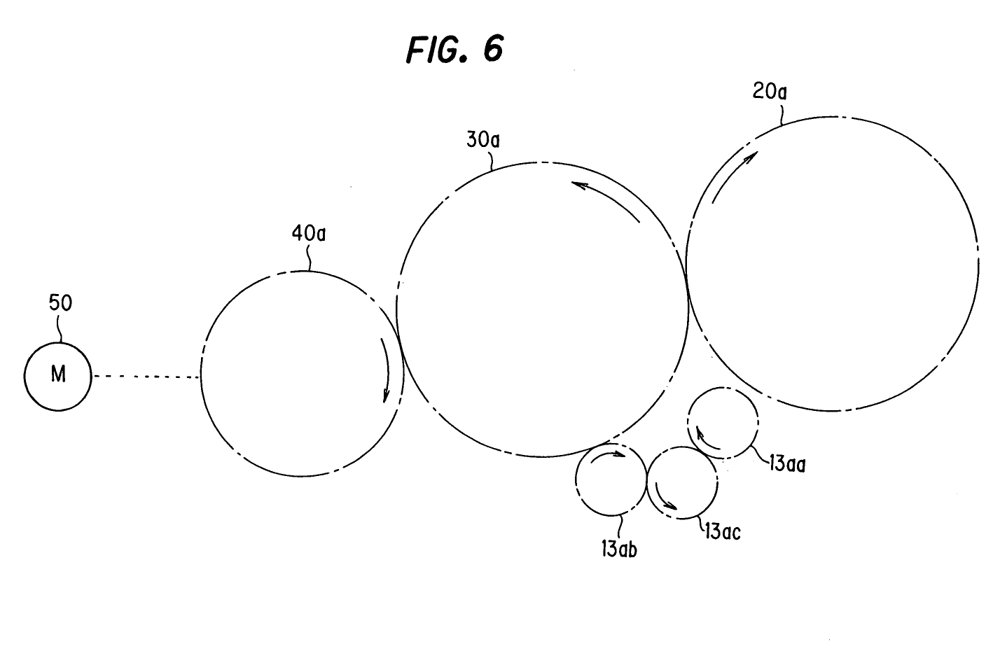

As shown in FIGS. 1 and 2, a drive shaft 13a is disposed in parallel with the axial direction of the jaw cylinder 20 while being located (at the lower left in FIG. 1) between the tension rollers 12 and the point of closest gap between the jaw cylinder 20 and the folding cylinder 30. The drive end of the drive shaft 13a is coaxially attached to a drive gear 13a a (see FIG. 6), which is connected to a drive source 50 of the folding machine via a folding cylinder gear 30a of the folding cylinder 30, intermediate gears 13ab and 13ac, and the like. The drive source 50 rotates a jaw cylinder gear 20a of the jaw cylinder 20, the folding cylinder gear 30a of the folding cylinder 30, a cutting cylinder gear 40a of the cutting cylinder 40, and the like. A plurality of support arms 13b are fixedly supported on the drive shaft 13a at their midpoint portions while being arranged at predetermined intervals along the width direction of the jaw cylinder 20. Each of the support arms 13b has guide rollers 13c rotatably attached to corresponding opposite end portions thereof. The guide rollers 13c are disposed in such a manner as to be interposed between the jaw cylinder 20 and the corresponding transport belts 10.

When the drive source 50 of the folding machine is activated, the drive shaft 13a is rotated, via the intermediate gears 13ab and 13ac and the drive gear 13aa, together with the jaw cylinder gear 20a of the jaw cylinder 20, the folding cylinder gear 30a of the folding cylinder 30, the cutting cylinder gear 40a of the cutting cylinder 40, and the like. As a result, the support arms 13b are rotated, and thus the guide rollers 13c revolve around the drive shaft 13a to thereby rotate eccentrically, between the jaw cylinder 20 and the corresponding transport belts 10.

The drive shaft 13a rotates such that its rotational cycle is synchronized with that of the jaw cylinder 20 and the folding cylinder 30, so as to yield the following effect. At the time of gripping change from the folding cylinder 30 to the jaw cylinder 20, the longitudinal direction of the support arms 13b coincides with the vertical direction; i.e., the transport belts 10 are caused to leave the folding cylinder 30 and to retreat toward the gripper boards 21 of the jaw cylinder 20. At a time other than the time of gripping change, the longitudinal direction of the support arms 13b coincides with the horizontal direction; i.e., the transport belts 10 are caused to abut a portion of the folding cylinder 30 located upstream, in relation to the rotational direction, of the point of closest gap between the folding cylinder 30 and the jaw cylinder 20.

In the present embodiment, the drive shaft 13a, the support arms 13b, and the like constitute eccentric movement means; and the eccentric movement means, the guide rollers 13c, and the like constitute the belt-moving means.

Transport belts (not shown) are disposed downstream (at the top in FIG. 1), in relation to the rotational direction, of the point of closest gap between the jaw cylinder 20 and the folding cylinder 30 while facing the corresponding transport belts 10, in order to transport a signature in cooperation with the transport belts 10.

Operation of the thus-configured parallel folding apparatus of a folding machine according to the present embodiment will next be described.

When the printed web 1 travels through the gap between the cutting cylinder 40 and the folding cylinder 30, the cutting blade of the cutting cylinder 40 transversely cuts the web 1 to form a sheet. The pin 31 of the folding cylinder 30 projects and sticks into a leading end portion of the sheet of the web 1, thereby holding the sheet. Thus, the sheet is transported while being guided by the above-mentioned guide plate.

At this time, the aforementioned synchronous rotation of the drive shaft 13a causes the guide rollers 13c to revolve around the drive shaft 13a and thus to rotate eccentrically such that the transport belts 10 are moved in such a manner as to abut a portion of the folding cylinder 30 located upstream, in relation to the rotational direction, of the point of closest gap between the folding cylinder 30 and the jaw cylinder 20. Therefore, the transport belts 10 press, against the folding cylinder 30, the sheet 2 that is being transported while being held on the folding cylinder 30.

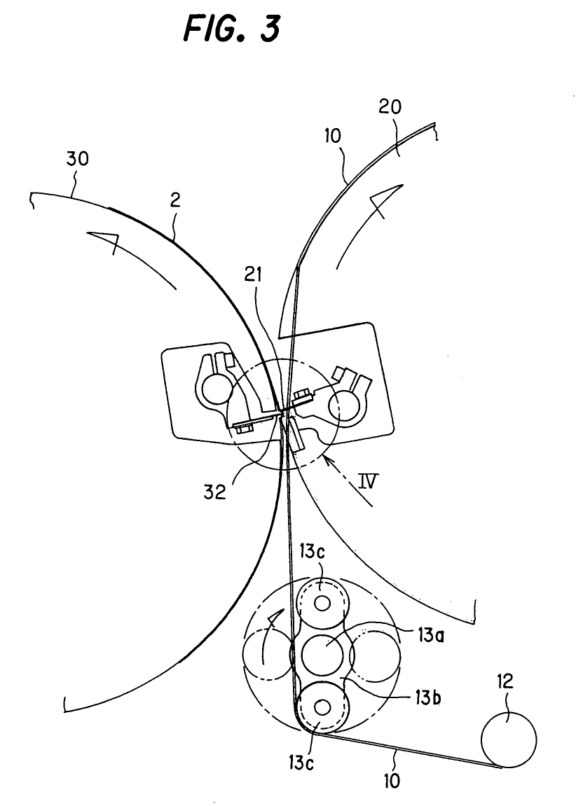

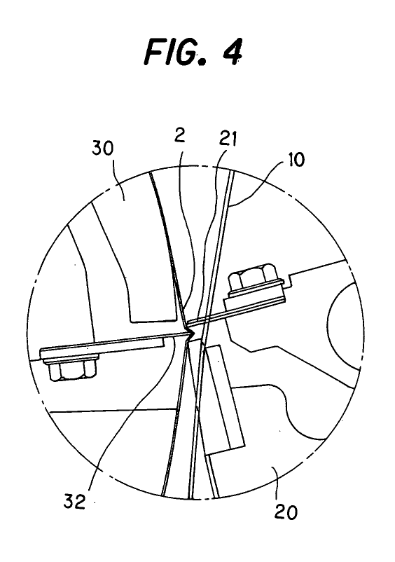

When the midpoint portion of the sheet 2 reaches the point of closest gap between the folding cylinder 30 and the jaw cylinder 20; i.e., at the time of gripping change from the folding cylinder 30 to the jaw cylinder 20, as shown in FIGS. 3 and 4, the aforementioned synchronous rotation of the drive shaft 13a causes the guide rollers 13c to revolve around the drive shaft 13a and thus to rotate eccentrically such that the transport belts 10 are caused to leave the folding cylinder 30 and to retreat toward the gripper board 21 of the jaw cylinder 20. In this state, the folding blade 32 of the folding cylinder 30 projects and folds the midpoint portion of the sheet 2 into a projecting shape; thus, the transport belts 10 do not come into contact with the projecting folding blade 32.

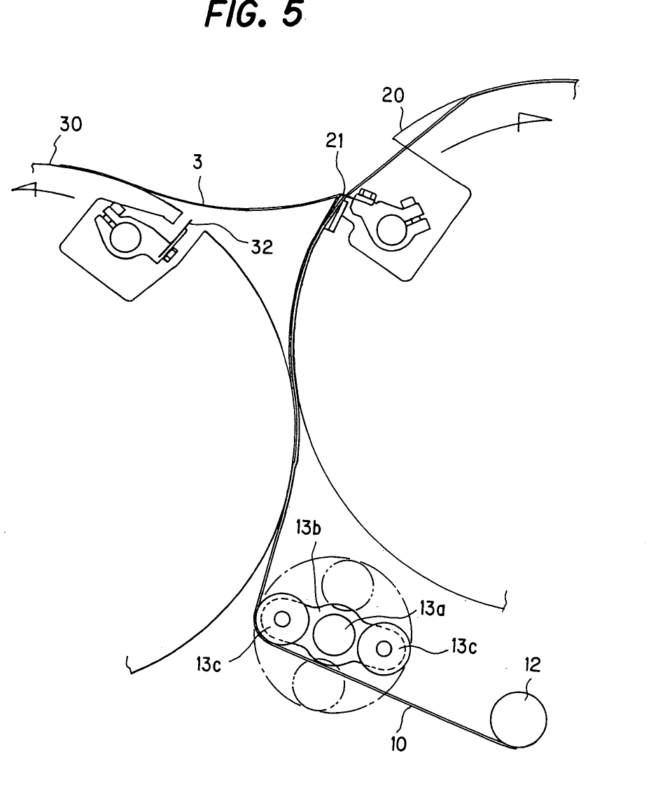

Subsequently, the gripper board 21 of the jaw cylinder 20 closes to thereby grip the projecting midpoint portion of the sheet 2; the folding blade 32 of the folding cylinder 30 retracts; and the pin 31 of the folding cylinder 30 retracts to thereby release the sheet 2 from retainment on the folding cylinder 30. Thus, as shown in FIG. 5, the sheet 2 is transferred as a transversely folded signature 3 from the folding cylinder 30 to the jaw cylinder 20.

After gripping change, the aforementioned synchronous rotation of the drive shaft 13a causes the guide rollers 13c to revolve around the drive shaft 13a and thus to rotate eccentrically such that, as shown in FIG. 5, the transport belts 10 are moved again in such a manner as to abut a portion of the folding cylinder 30 located upstream, in relation to the rotational direction, of the point of closest gap between the folding cylinder 30 and the jaw cylinder 20. Therefore, the transport belts 10 press the tail edge of the signature 3 against the folding cylinder 30 until sheet transfer from the folding cylinder 30 to the jaw cylinder 20 is completed.

When the signature 3 is transported to a position where the signature 3 is transferred from the jaw cylinder 20 to the transport belts 10 and the like, the gripper board 21 of the jaw cylinder 20 opens to thereby release the signature 3 from the jaw cylinder 20. The signature 3 is transported to the next downstream process while being held by means of the transport belts 10 and the like.

According to the present embodiment, the aforementioned synchronous rotation of the drive shaft 13a causes the guide rollers 13c to revolve around the drive shaft 13a and thus to rotate eccentrically such that the transport belts 10 are moved to yield the following effect. At a time other than the time of gripping change from the folding cylinder 30 to the jaw cylinder 20, the transport belts 10 abut a portion of the folding cylinder 30 located upstream of the point of closest gap between the folding cylinder 30 and the jaw cylinder 20. At the time of gripping change, the transport belts 10 leave the folding cylinder 30 and retreat toward the jaw cylinder 20; more specifically, the transport belts 10 are moved toward the jaw cylinder 20 in relation to the position where the sheet 2 is gripped by means of a cooperative action between the folding blade 32 of the folding cylinder 30 and the gripper board 21 of the jaw cylinder 20.

Thus, according to the present embodiment, the tail edge of the signature 3 is pressed against the folding cylinder 30 at the time of sheet transfer from the folding cylinder 30 to the jaw cylinder 20, thereby preventing contact of the transport belts 10 with the folding blade 32 engaged in gripping change from the folding cylinder 30 to the jaw cylinder 20 while preventing the aforementioned flutter which would otherwise result from high-speed operation.

Therefore, the parallel folding apparatus of a folding machine according to the present embodiment can enhance the fold accuracy of the signature 30 associated with sheet transfer from the folding cylinder 30 to the jaw cylinder 20 in high-speed operation.

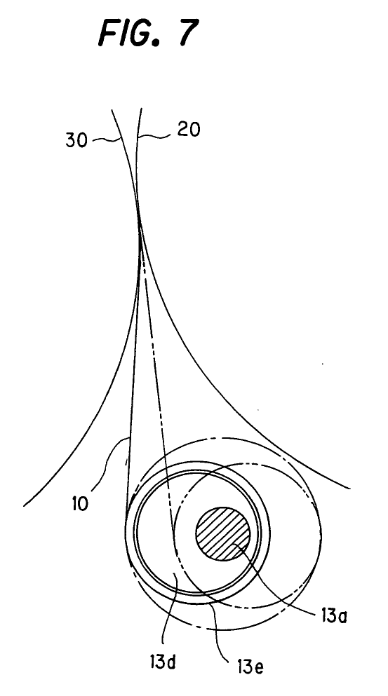

According to the present embodiment, the support arms 13b rotate to thereby effect eccentric rotation of the guide rollers 13c through revolution, and the eccentrically moving guide rollers 13c move the transport belts 10 accordingly. However, the present invention is not limited thereto. For example, the following another embodiment may be possible. As shown in FIG. 7, in place of using the support arms 13b and the guide rollers 13c, guide rollers 13e disposed between the jaw cylinder 20 and the transport belts 10 are attached to the drive shaft 13a via an eccentric sleeve 13d. The drive shaft 13a, the eccentric sleeve 13d, and the like constitute eccentric rotation means; and the eccentric rotation means, the guide rollers 13e, and the like constitute the belt-moving means. The transport belts 10 are moved in accordance with eccentric rotation of the guide rollers 13e caused by eccentric rotation of the eccentric sleeve 13d.

What is claimed is:

1. A parallel folding apparatus of a folding machine, comprising:
a folding cylinder having holding means for holding a sheet, and a folding blade;
a jaw cylinder opposing said folding cylinder and having a gripper member which performs, in cooperation with said folding blade of said folding cylinder, a gripping change of said sheet held by said holding means of said folding cylinder in such a manner that said sheet is gripped by said gripper member while being folded to form a signature;
a belt looped around said jaw cylinder; and
belt-moving means for moving, toward said jaw cylinder, a portion of said belt located upstream of a point of closest gap between said folding cylinder and said jaw cylinder and biased toward said folding cylinder, at the time of the gripping change of said sheet from said folding cylinder to said jaw cylinder.

2. A parallel folding apparatus of a folding machine according to claim 1, wherein said belt-moving means includes a guide roller interposed between said jaw cylinder and said belt and arranged to rotate eccentrically.

3. A parallel folding apparatus of a folding machine according to claim 1, wherein said belt-moving means includes,
a pair of guide rollers interposed between said jaw cylinder and said belt,
a support arm having said guide rollers rotatably attached to opposite end portions thereof, and
a drive shaft adapted to rotate said support arm while supporting said support arm at a midpoint portion thereof.

4. A parallel folding apparatus of a folding machine according to claim 1, wherein, at the time of gripping change, said belt-moving means moves said belt away from said folding cylinder such that said belt retreats toward said gripper member of said jaw cylinder.

5. A parallel folding apparatus of a folding machine according to claim 1, wherein, at the time of gripping change, said belt-moving means moves said belt such that said belt is located between the center of said jaw cylinder and said position where said sheet is gripped by means of a cooperative action between said folding blade of said folding cylinder and said gripper member of said jaw cylinder.

6. A parallel folding apparatus of a folding machine according to claim 1, wherein, at a time other than the time of gripping change, said belt-moving means moves said belt such that said belt abuts a portion of said folding cylinder located upstream, in relation to a rotational direction, of the point of closest gap between said folding cylinder and said jaw cylinder.

7. A parallel folding apparatus of a folding machine according to claim 1, wherein said belt-moving means is operated by means of a drive source of said folding machine in such a manner as to be synchronized with a rotational cycle of said jaw cylinder and said folding cylinder.
